(19) United States
(12) Patent Application Publication
(10) Pub. No.: US 2013/0278773 A1
(43) Pub. Date: Oct. 24, 2013

(54) CAMERA SYSTEM, MONITORING CAMERA CONTROL TERMINAL, AND PROTOCOL CHANGING METHOD

(71) Applicant: HITACHI, LTD., Tokyo (JP)

(72) Inventors: Hirotaka MORIBE, Yokohama (JP); Masuo OKU, Kamakura (JP); Minoru KOIZUMI, Tokyo (JP); Tomoichi EBATA, Machida (JP); Nagamasa MIZUSHIMA, Yokohama (JP)

(73) Assignee: HITACHI, LTD., Tokyo (JP)

(21) Appl. No.: 13/868,431

(22) Filed: Apr. 23, 2013

(30) Foreign Application Priority Data
Apr. 24, 2012 (JP) 2012-098325

(51) Int. Cl. H04N 7/18

(52) U.S. Cl. CPC H04N 7/181
USPC 348/159

(57) ABSTRACT

A monitoring camera control terminal and a monitoring camera apparatus respectively correspond to a plurality of protocols defining messages instructing a variety of settings and operations between the monitoring camera control terminal and the monitoring camera apparatus, and the monitoring camera control terminal uses a first protocol to request the monitoring camera apparatus for information related to the monitoring camera apparatus, receives the requested information from the monitoring camera apparatus, and if the requested information does not match the setting or operation information recorded in a storage part of the monitoring camera control terminal, changes the first protocol to a second protocol.

### CROSS-REFERENCE TO RELATED APPLICATIONS

The present application claims the benefit of priority to Japanese Patent Application No. 2012-098325, filed Apr. 24, 2012, of which full contents are incorporated herein by reference.

### BACKGROUND OF THE INVENTION

The present invention relates to a camera system, a monitoring camera control terminal and a protocol changing method.

There is a monitoring camera system that is provided with a monitoring camera apparatus which can send a captured image through a network and can be connected to the network, and a monitoring camera control terminal which can display the image captured by the monitoring camera apparatus after receiving it through the network.

Some monitoring camera apparatuses which configure the monitoring camera system and which are network connectable are provided with a function to set a variety of functions provided for the monitoring camera apparatus from a remote monitoring camera control terminal through the network, or a function to receive instructions to perform operations such as panning, tilting, and zooming.

As a protocol specifying communication messages for instructing a variety of settings and operations which are performed between the monitoring camera apparatus and the monitoring camera control terminal through the network, an original protocol which can be used by each company between its own products only was mostly defined and used conventionally. But, today there have appeared standard protocols which can be used in common between the products of two or more companies.

To newly meet a standard protocol in development of products such as the monitoring camera apparatus and the monitoring camera control terminal, it is necessary to develop new software for realizing control using the standard protocol and to apply to the individual products.

It is generally presumed that newly developed software has a large number of defects. But software for realizing the control using an original protocol of each company has a good record of being applied to each product and used up to now for a certain period and its defects which have become obvious are being fixed. Therefore, it is presumed that software quality has become higher.

In such a case, to realize control for setting, operation and the like more securely between the monitoring camera apparatus and the monitoring camera control terminal, it is general to use a technique that both of software for realizing control using an original protocol which is assumed to have higher quality and software for realizing control using a newly developed standard protocol are applied to provide multiplexed software for controlling, and if either of them had a problem, switching to the other is performed.

As a technology for improving the availability of the whole apparatus by multiplexing the software as described above, for example, Japanese Patent Laid-Open No. 2002-333990 is directed to updating of a program and proposes a method that stores both of a currently operating program and a new program which is an updated version of the former program, and if a startup failure of the new program is detected, the operating program before updating is used to continue the operation of the device.

### SUMMARY OF THE INVENTION

However, according to the method of the above-described publication which changes software to be used by monitoring a software process state such as a startup failure, setting by the operator is not reflected or the operation desired by the operator is not performed due to a defect or the like in software. Thus, such a failure in internal processing of software cannot be detected regardless of running of the process. And a variety of operations and behaviors may be continued against the intension of the operator, causing problems in use of a camera system and a monitoring camera apparatus.

The present invention has been achieved under the circumstances described above, and it is an object of the present invention to provide a camera system, a monitoring camera control terminal and a protocol changing method that can enhance the availability of the control of a monitoring camera so that a defect in software or the like of a monitoring camera apparatus does not cause the monitoring camera apparatus to perform an operation which does not meet an operator's intention, to make the operation inoperable, to deliver motion images in a state different from the intended one, or to stop delivery of motion images.

A typical example of the present invention is as follows. That is, the present invention relates to a monitoring camera control terminal connected to a monitoring camera apparatus through a network. The monitoring camera apparatus and the monitoring camera control terminal correspond to plural protocols defining messages respectively instructing a variety of settings and operations between the monitoring camera apparatus and the monitoring camera control terminal. The monitoring camera control terminal uses a first protocol to request the monitoring camera apparatus for information related to the monitoring camera apparatus, receives the requested information from the monitoring camera apparatus, and if the requested information does not match the operation information or setting recorded in the storage part of the monitoring camera control terminal, changes the first protocol to a second protocol.

According to the present invention, the availability of the control of the monitoring camera apparatus can be enhanced so that a defect in software or the like of the monitoring camera apparatus does not cause the monitoring camera apparatus to operate against the intention of the operator to make the operation inoperable, to deliver motion images in a state different from the intended one, or to stop delivery of the motion images.

Other objects, features, and advantages of the present invention will become apparent from the following description of embodiments of the present invention provided in relation to the accompanying drawings.

### BRIEF DESCRIPTION OF THE DRAWINGS

FIG. 1 is a diagram showing a structure of a camera system 1 according to an embodiment of the invention.

FIG. 2 is a diagram showing the hardware structure of a monitoring camera control terminal 3 according to the embodiment of the invention.

FIG. 3 is a diagram showing the hardware structure of a monitoring camera apparatus 4 according to the embodiment of the invention.

FIG. 4 is a functional block diagram of the monitoring camera control terminal 3 according to the embodiment of the invention.

FIG. 5 is a functional block diagram of the monitoring camera apparatus 4 according to the embodiment of the invention.

FIG. 6 is a flow chart showing a flow of protocol startup processing of the monitoring camera apparatus 4 according to the embodiment of the invention.

FIG. 7 is a flow chart showing a flow of monitoring camera control terminal processing of the monitoring camera control terminal 3 according to the embodiment of the invention.

FIG. 8 is an interaction diagram showing a flow of communication and processing between the monitoring camera control terminal 3 and the monitoring camera apparatus 4 in a use case of using setting information in the camera system 1 according to the embodiment of the invention.

FIG. 9 is an interaction diagram showing a flow of communication and processing between the monitoring camera control terminal 3 and the monitoring camera apparatus 4 in a use case of using motion image data in the camera system 1 according to the embodiment of the invention.

### DESCRIPTION OF THE EMBODIMENTS

A camera system 1 according to an embodiment of the present invention will be described below with reference to the drawings.

### System Structure

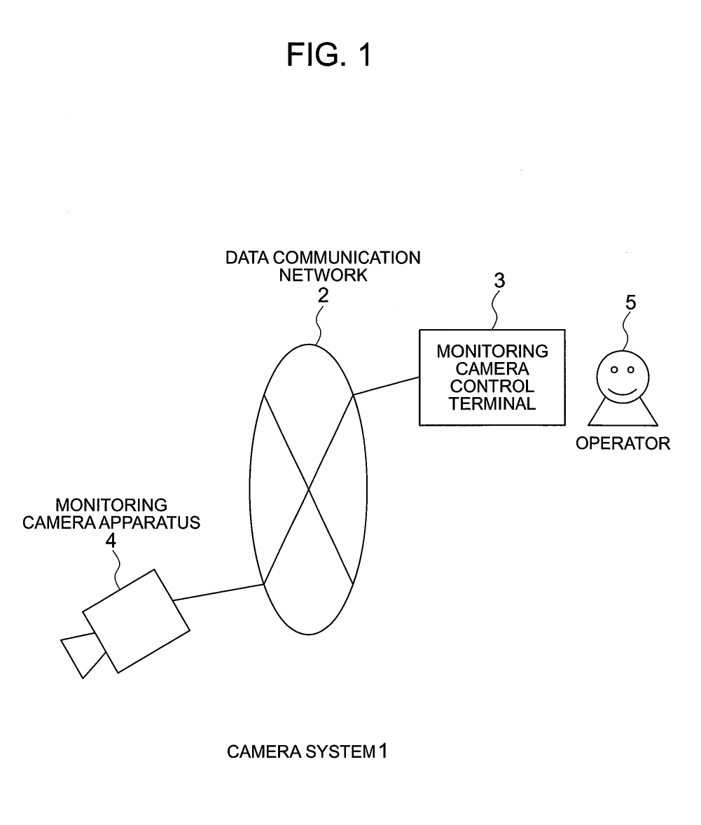

FIG. 1 is a diagram showing a structure example of the camera system 1 according to this embodiment.

The camera system 1 of this embodiment includes a data communication network 2, a monitoring camera control terminal 3, a monitoring camera apparatus 4, and an operator 5 who operates the monitoring camera control terminal 3. The monitoring camera control terminal 3 and the monitoring camera apparatus 4 are connected to the data communication network 2 and can communicate mutually through the data communication network 2.

The data communication network 2 comprises, for example, a mobile telephone network, a LAN (Local Area Network) including wireless and wired, an internet network having LANs connected mutually, or the like.

The monitoring camera control terminal 3 is connected to the data communication network 2 by wireless or cable and can display on a screen by receiving the motion image captured by the monitoring camera apparatus 4 described later through the data communication network 2. And, a variety of control messages can be sent to the monitoring camera apparatus 4 to make setting of a variety of functions possessed by the monitoring camera apparatus 4, a request for and acquisition of a message including a variety of setting information, and a variety of operations such as panning, tilting and zooming of the monitoring camera apparatus 4 which can perform panning, tilting and zooming. The monitoring camera control terminal 3 is comprised of single or plural equipment, such as a personal computer, a server device, a system combining a set-top box and a monitor, and a dedicated device.

The monitoring camera apparatus 4 can be connected to the data communication network 2 by wireless or cable and can deliver the captured motion image to the monitoring camera control terminal 3 through the data communication network 2. And, by receiving a variety of types of control messages from the monitoring camera control terminal 3, setting of a variety of functions possessed by the monitoring camera apparatus 4 is made, a message including a variety of setting information responding to the request of the monitoring camera control terminal 3 is sent back, and when it is possible to perform panning, tilting and zooming and when it is instructed to perform a variety of operations such as panning, tilting and zooming, such operations are performed. The monitoring camera apparatus 4 is, for example, a monitoring camera, a camera for TV conference system, a camera for game machine connection, or the like.

The operator 5 operates the monitoring camera control terminal 3 to perform a desired operation such as a variety of settings of the monitoring camera apparatus 4, reference to a variety of setting information of the monitoring camera apparatus 4, or an operation to perform panning, tilting or zooming of the monitoring camera apparatus 4.

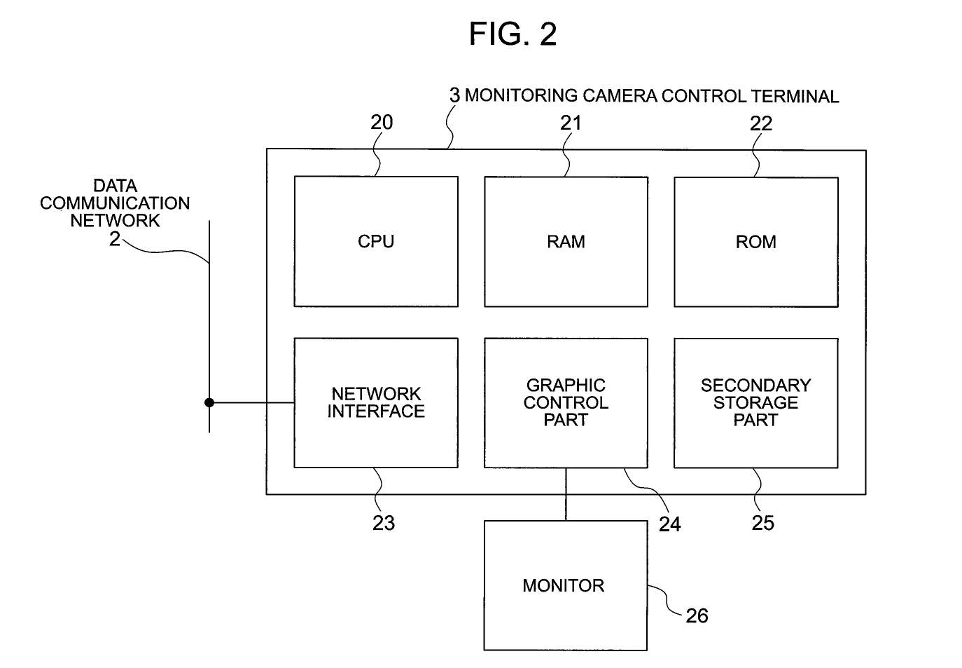

FIG. 2 is a diagram showing the hardware structure of the monitoring camera control terminal 3 according to this embodiment. The monitoring camera control terminal 3 has a CPU 20 which wholly controls the monitoring camera control terminal 3, a RAM (Random Access Memory) 21 and a ROM (Read Only Memory) 22 which store data and programs, a network interface 23 which sends/receives data to/from the data communication network 2 by cable or wireless, a graphic control part 24 which controls to display information on a connected monitor 26, a secondary storage part 25 which can record/delete data, and the monitor 26 which can display a variety of pieces of information on a screen. The secondary storage part 25 which can record/delete data may be a HDD (Hard Disk Drive), an SSD (Solid State Drive), a memory card or the like depending on a type of the monitoring camera control terminal 3.

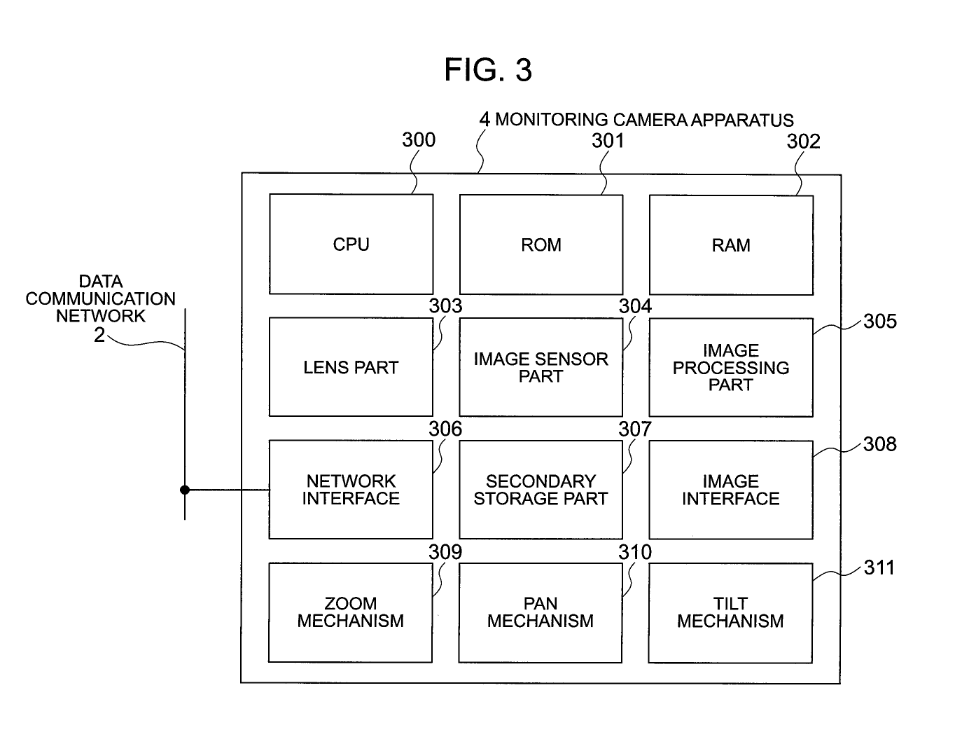

FIG. 3 is a diagram showing the hardware structure of the monitoring camera apparatus 4 according to this embodiment. The monitoring camera apparatus 4 has a CPU 300 which wholly controls the monitoring camera apparatus 4, a ROM (Read Only Memory) 301 and a RAM (Read Only Memory} 302 which store data and programs, a lens part 303 which is provided with an optical lens, an image sensor part 304 which detects the light obtained by the lens part 303 and converts to digital data, an image processing part 305 which processes the digital data obtained by the image sensor part 304 as motion image data, a network interface 306 which sends/receives data to/from the data communication network 2 by cable or wireless, a secondary storage part 307 which can record/delete data, an image interface 308 which outputs outside the motion image data obtained by the image processing part 305, a zooming mechanism 309 which is a movable mechanism for adjusting zoom by moving the lens part 303, a panning mechanism 310 which is a movable mechanism for adjusting the direction of the lens part 303 by moving the lens part 303 horizontally, and a tilting mechanism 311 which is a movable mechanism for adjusting the direction of the lens part 303 by moving the lens part 303 vertically. Any of the zooming mechanism 309, the panning mechanism 310 and the tilting mechanism 311, or all of them may not be provided depending on a type of the monitoring camera apparatus 4. And, the secondary storage part 307 which can record/delete data may be a HDD (Hard Disk Drive), an SSD (Solid State Drive), a memory card or the like, or may not be provided depending on a type of the monitoring camera apparatus 4.

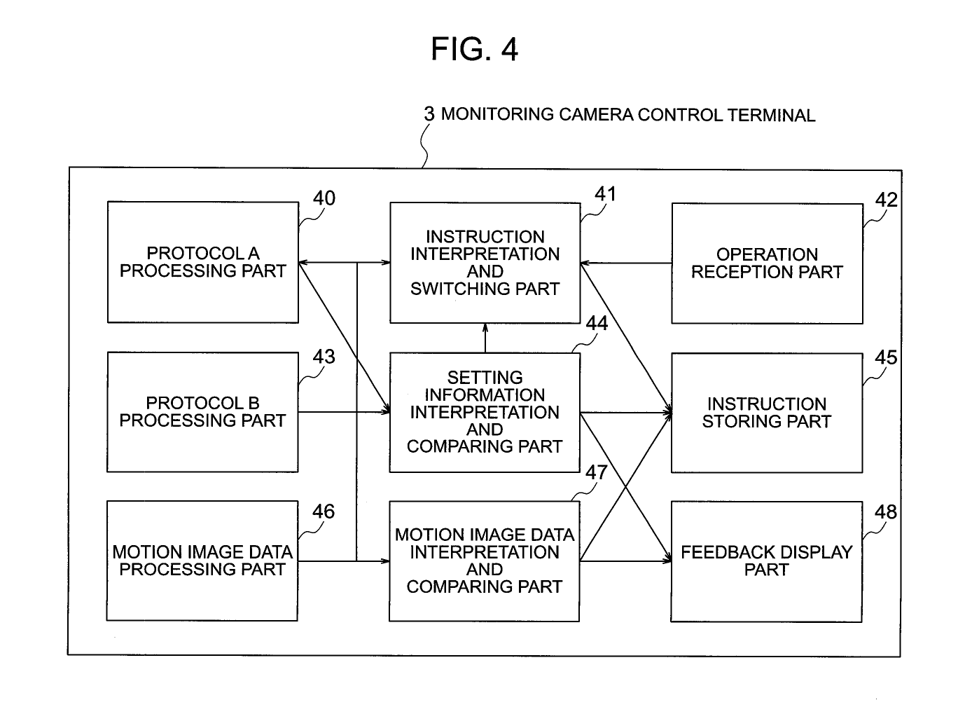

FIG. 4 is a diagram showing a functional block of the monitoring camera control terminal 3 according to this embodiment.

The monitoring camera control terminal 3 comprises a protocol A processing part 40, an instruction interpretation and switching part 41, an operation reception part 42, a protocol B processing part 43, a setting information interpretation and comparing part 44, an instruction storing part 45, a motion image data processing part 46, a motion image data interpretation and comparing part 47, and a feedback display part 48.

The protocol A processing part 40 can send a variety of control messages of protocol A designated by the instruction interpretation and switching part 41 to be described later to the monitoring camera apparatus 4. The protocol A processing part 40 can also receive a response message from the monitoring camera apparatus 4 in response to the variety of control messages. The protocol A is a group of control messages in which messages for controlling the monitoring camera apparatus 4 are systematically defined.

The instruction interpretation and switching part 41 selects a control message of the protocol A or the protocol B responding to the instructions obtained from the operation reception part 42 to be described later and transmits together with information, which is required to configure the control message obtained from the operation reception part 42 to be described later, to the protocol A processing part 40 or the protocol B processing part 43 to be described later. The instruction interpretation and switching part 41 transmits to only one of the protocol A processing part 40 and the protocol B processing part 43 until the protocol is changed. In this embodiment, it is determined to use the protocol A processing part 40 initially. When it is transmitted from the setting information interpretation and comparing part 44 or the motion image data interpretation and comparing part 47 to be described later that setting information does not match, the instruction interpretation and switching part 41 performs switching from the currently using protocol to the other protocol.

The operation reception part 42 performs processing to receive instructions of the operator 5 for a variety of settings and operations to the monitoring camera apparatus 4 via a user interface such as a GUI.

The protocol B processing part 43 can send a variety of control messages of the protocol B designated by the instruction interpretation and switching part 41 to the monitoring camera apparatus 4. The protocol B processing part 43 can also receive a response message responding to the variety of control messages from the monitoring camera apparatus 4. The protocol B is a group of control messages in which messages for controlling the monitoring camera apparatus 4 are systematically defined. The protocol B has a message group for controlling the monitoring camera apparatus 4 determined by a message group different from the message group defined by the protocol A and is defined to be a protocol which is provided with each control message capable of instructing the same control in correspondence with each control message defined by the protocol A. That is, it is determined that the protocol A and the protocol B are respectively provided with a control message for giving substantially the same control instructions by different systems.

The setting information interpretation and comparing part 44 refers to setting information contained in a response message responding to the request for obtaining setting information or the like sent by the protocol A processing part 40 or the protocol B processing part 43, and compares with the setting information contained in the instruction storing part 45 to be described later. If the compared result shows that the setting information does not match the setting information recorded in the instruction storing part 45 desired by the operator 5, the setting information interpretation and comparing part 44 transmits the compared result to the instruction interpretation and switching part 41.

The instruction storing part 45 sequentially obtains and sequentially records and accumulates a control message of the protocol A or protocol B responding to the instruction obtained by the operation reception part 42 and information required to configure the control message from the instruction interpretation and switching part 41. Such information is referred to, and setting information of the monitoring camera apparatus 4 now desired by the operator 5 can be grasped. The instruction storing part 45 is referred to by the setting information interpretation and comparing part 44 and the motion image data interpretation and comparing part 47 described later.

The motion image data processing part 46 receives motion image data delivered from the monitoring camera apparatus 4 which is requested by the protocol A processing part 40 or the protocol B processing part 43. The motion image data received by the motion image data processing part 46 is transmitted to the motion image data interpretation and comparing part 47.

The motion image data interpretation and comparing part 47 performs decode processing or the like of the motion image data transmitted from the motion image data processing part 46, obtains the motion of the lens part 303 from setting information obtained from the motion image data such as a codec, resolution, a frame rate, a bit rate and the like and the whole tendency of movement of each pixel in the motion image data, and compares with the setting information and operation information contained in the instruction storing part 45. If the compared result shows that the setting or the operation information does not match the setting or the operation information recorded in the instruction storing part 45 desired by the operator 5, the motion image data interpretation and comparing part 47 transmits the compared result to the instruction interpretation and switching part 41.

The feedback display part 48 performs processing to display the present setting information and motion image data of the monitoring camera apparatus 4 obtained by the setting information interpretation and comparing part 44 and the motion image data interpretation and comparing part 47. According to the processing performed by the feedback display part 48, the operator 5 can refer to a variety of setting information and motion image data obtained from the monitoring camera apparatus 4.

The above respective processings 40 to 48 are realized by expanding the programs stored in the secondary storage part 25 and the ROM 22 into the RAM 21 and executing by the CPU 20 while using the functions of the network interface 23 and the graphic control part 24.

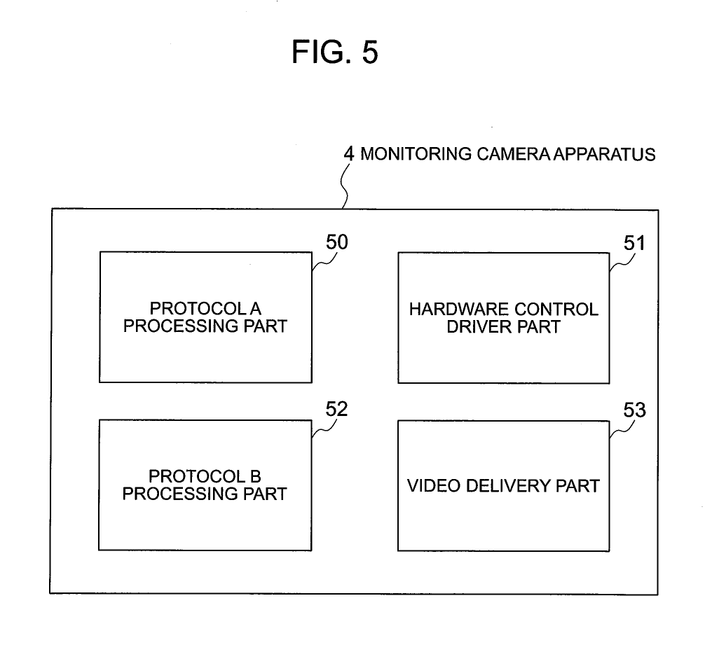

FIG. 5 is a diagram showing a functional block of the monitoring camera apparatus 4 according to this embodiment.

The monitoring camera apparatus 4 comprises a protocol A processing part 50, a hardware control driver part 51, a protocol B processing part 52, and a video delivery part 53.

The protocol A processing part 50 can receive a variety of control messages of protocol A sent from the protocol A processing part 40 of the monitoring camera control terminal 3. The protocol A processing part 50 can also send a response message responding to the variety of control messages to the protocol A processing part 40 of the monitoring camera control terminal 3. When the variety of control messages are received and they are messages for setting the respective functions provided to the monitoring camera apparatus 4 and messages for performing operations such as panning, tilting, and zooming of the monitoring camera apparatus 4, the protocol A processing part 50 transmits the instructions of the control message to the hardware control driver part 51. If the control message is a message for requesting the delivery of the motion image data, the instruction of the control message is transmitted to the video delivery part 53.

The hardware control driver part 51 transmits the control message transmitted from the protocol A processing part 50 or the protocol B processing part 52 to be described later to a variety of drivers for controlling the functions of hardware, such as the image processing part 305, the network interface 306, the image interface 308, the zooming mechanism 309, the panning mechanism 310 and the tilting mechanism 311, which are provided to the monitoring camera apparatus 4 and executes control for settings or the like of a variety of hardware designated by the control messages.

The protocol B processing part 52 can receive a variety of control messages of the protocol B sent from the protocol B processing part 43 of the monitoring camera control terminal 3. The protocol B processing part 52 can also send response messages responding to the variety of control messages to the protocol B processing part 43 of the monitoring camera control terminal 3. When the variety of control messages are received and they are messages for setting a variety of functions provided to the monitoring camera apparatus 4 and messages for performing operations such as panning, tilting, and zooming of the monitoring camera apparatus 4, the protocol B processing part 52 transmits instructions of the control message to the hardware control driver part 51. If the control message is a message for requesting the delivery of the motion image data, the instruction of the control message is transmitted to the video delivery part 53.

The video delivery part 53 receives the transmission from the protocol A processing part 50 or the protocol B processing part 52 of the monitoring camera apparatus 4 which has received a control message requesting the delivery of motion image data sent from the protocol A processing part 40 or the protocol B processing part 43 of the monitoring camera control terminal 3, and sends the motion image data obtained by the image processing part 305 of the monitoring camera apparatus 4 to the motion image data processing part 46 of the monitoring camera control terminal 3.

The above-described processing parts 50 to 53 are embodied by executing by the CPU 300 that the programs stored in the secondary storage part 307 and the ROM 31 are expanded in the RAM 302 while the functions of the image processing part 305, the network interface 306, the image interface 308, the zooming mechanism 309, the panning mechanism 310, and the tilting mechanism 311 are being used.

### System Processing

Details of processing by the monitoring camera control terminal 3 and the monitoring camera apparatus 4 according to this embodiment are described below. This is to clarify a method that the operation desired by the operator 5 can be executed continuously by automatically switching protocols of a variety of control messages which are sent to the monitoring camera apparatus 4 by the monitoring camera control terminal 3.

### Monitoring Camera Apparatus Processing

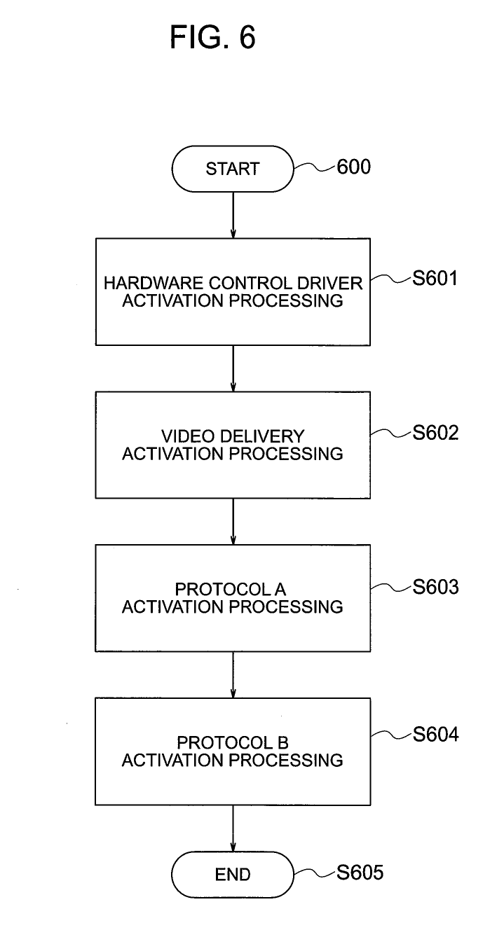

FIG. 6 is a diagram explaining a flow of protocol startup processing 600 in the monitoring camera apparatus 4. The protocol startup processing 600 is executed immediately after the monitoring camera apparatus 4 is powered on.

In S601, the hardware control driver part 51 is activated to put the image sensor part 304, the image processing part 305, the network interface 306, the image interface 308, the zooming mechanism 309, the panning mechanism 310, and the tilting mechanism 311 of the monitoring camera apparatus 4 into a state capable of controlling the hardware control driver part 51, and the processing is advanced to S602.

In S602, the video delivery part 53 is activated, an image is taken by the lens part 303 of the monitoring camera apparatus 4, motion image data processed by the image sensor part 304 and the image processing part 305 is put into a state that it can be delivered, and the processing is advanced to S603.

In S603, the protocol A processing part 50 is activated to have a state that reception of a variety of control messages and motion image data delivery requests from the monitoring camera control terminal 3 according to the protocol A and a response to the control messages can be made, and the processing is advanced to S604.

In S604, the protocol B processing part 52 is activated to have a state that reception of a variety of control messages and motion image data delivery requests from the monitoring camera control terminal 3 according to the protocol B and a response to the control message can be made, and the processing is terminated (S605).

The flow of protocol startup processing by the monitoring camera apparatus 4 was described above.

### Monitoring Camera Control Terminal Processing

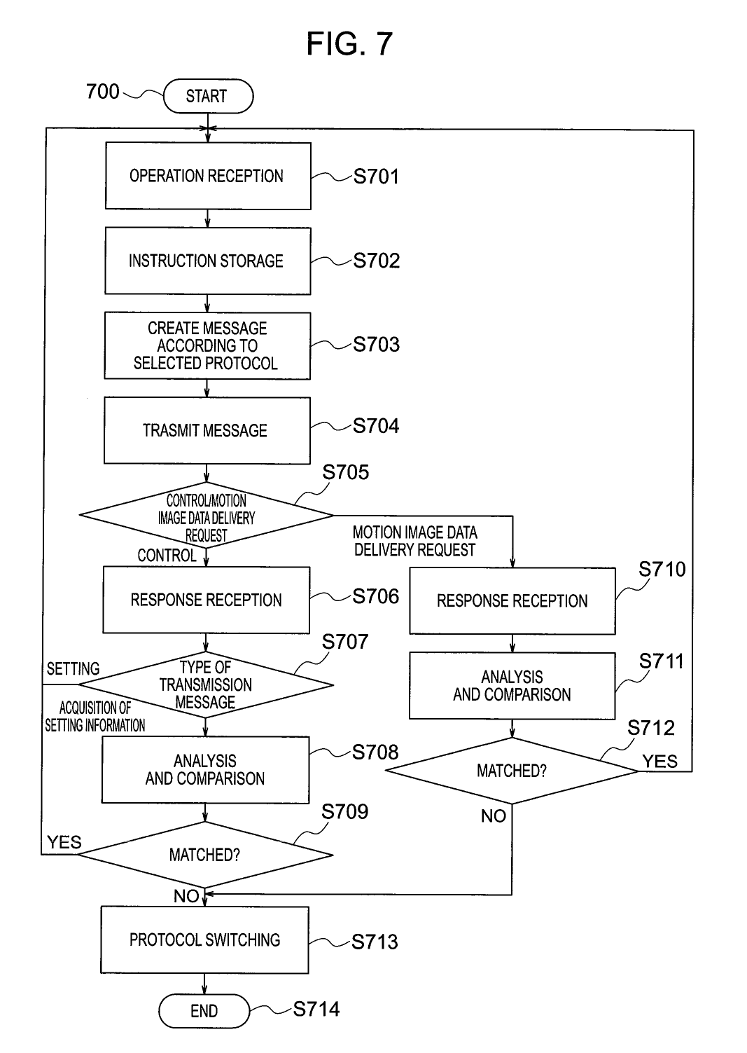

FIG. 7 is a diagram explaining a flow of monitoring camera control terminal processing 700 by the monitoring camera control terminal 3. The monitoring camera control terminal processing 700 is executed immediately after the monitoring camera control terminal 3 is powered on. In this case, the monitoring camera control terminal 3 is determined to use either protocol A or protocol B for the protocol to control the monitoring camera apparatus 4. In this embodiment, the protocol A is initially used.

In S701, the operation reception part 42 waits for the operation instructions from the operator 5 to the monitoring camera control terminal 3, and when the operation is instructed, the operation instruction is accepted, and the processing is advanced to S702.

In S702, the instruction interpretation and switching part 41 records sequentially the operation instruction obtained in S701 into the instruction storing part 45, and the processing is advanced to S703.

In S703, the instruction interpretation and switching part 41 transmits to the protocol A processing part 40 information required for creating a motion image delivery data request message or a variety of control messages to the monitoring camera apparatus 4 according to the protocol A responding to the operation instruction obtained in S701, and the processing is advanced to S704.

In S704, the protocol A processing part 40 uses the information transmitted in the S703 and sends the control message according to the protocol A or the motion image delivery data request message, and the processing is advanced to S705.

In S705, when the message sent in S704 is a control message for setting the monitoring camera apparatus 4 or for obtaining setting information, the protocol A processing part 40 advances the processing to S706. When the message sent in S704 is a motion image data delivery request message to the monitoring camera apparatus 4, the protocol A processing part 40 advances the processing to S710.

In S706, the protocol A processing part 40 waits for a response message from the monitoring camera apparatus 4 responding to the control message sent in S704, and when it receives the response message, the processing is advanced to S707.

In S707, when the message sent in S704 is a control message for setting the monitoring camera apparatus 4, the protocol A processing part 40 advances the processing to S701 and continues to control the monitoring camera apparatus 4. When the message sent in S704 is a control message for obtaining the setting information of the monitoring camera apparatus 4, the protocol A processing part 40 advances the processing to S708.

In S708, the setting information interpretation and comparing part 44 refers to the setting information obtained from the monitoring camera apparatus 4 in S706 and compares the setting information with the setting of the monitoring camera apparatus 4 recorded in the instruction storing part 45 desired by the operator 5 in S709 to see whether they match.

If they match in S709 as a compared result, the setting information interpretation and comparing part 44 judges that the setting of the monitoring camera apparatus 4 desired by the operator 5 matches the actual setting state of the monitoring camera apparatus 4, advances the processing to S701, and continues a variety of controls of the monitoring camera apparatus 4. If they do not match, the setting information interpretation and comparing part 44 judges that the setting of the monitoring camera apparatus 4 desired by the operator 5 does not match the actual setting state of the monitoring camera apparatus 4, and advances the processing to S713.

In S710, the motion image data processing part 46 waits for motion image data from the monitoring camera apparatus 4 responding to the motion image data delivery request message sent in S704, and when it receives the motion image data, advances the processing to S711.

In S711, the motion image data interpretation and comparing part 47 performs motion image data processing such as decode processing and the like on the motion image data received in S710, extracts information such as a codec, resolution, a frame rate, a bit rate and the like from the motion image data, or presumes the movement of the lens part 303 from the whole tendency of the movement of each pixel in the motion image data, and compares in S712 the information with the setting or operations of the monitoring camera apparatus 4 recorded in the instruction storing part 45 desired by the operator 5 to see whether or not they match.

If they match as a compared result in S712, the motion image data interpretation and comparing part 47 judges that the setting or operation of the monitoring camera apparatus 4 desired by the operator 5 matches the actual setting or operating state of the monitoring camera apparatus 4, advances the processing to S701, and continues a variety of controls of the monitoring camera apparatus 4. If they do not match, the motion image data interpretation and comparing part 47 judges that the setting or operation of the monitoring camera apparatus 4 desired by the operator 5 does not match the actual setting or operating state of the monitoring camera apparatus 4, and advances the processing to S713.

In S713, the instruction interpretation and switching part 41 judges that control of the currently used monitoring camera apparatus 4 using the protocol A has fallen in a state different from the setting desired by the operator 5, stops the control of the monitoring camera apparatus 4 using the protocol A, changes the protocol used to control the monitoring camera apparatus 4 to the protocol B, advances the processing to S714, and terminates the processing in S714.

After the protocol is changed in S713, the monitoring camera control terminal processing 700 using the protocol B is executed. The monitoring camera control terminal processing 700 using the protocol B has the same flow of processing except that the protocol A processing part 40 used at the time of the monitoring camera control terminal processing 700 using the protocol A is changed to the protocol B processing part 43.

The operator 5 can continue the desired control by performing the monitoring camera control terminal processing 700 using the highly reliable protocol B, and while the monitoring camera control terminal processing 700 using the protocol B is being performed, restart of software of the protocol A processing part 40 or fixture or replacement of a defect can be made by software updating or the like.

A flow of monitoring camera control terminal processing of the monitoring camera control terminal 3 was described above.

### Protocol Switching when Obtaining Setting Information

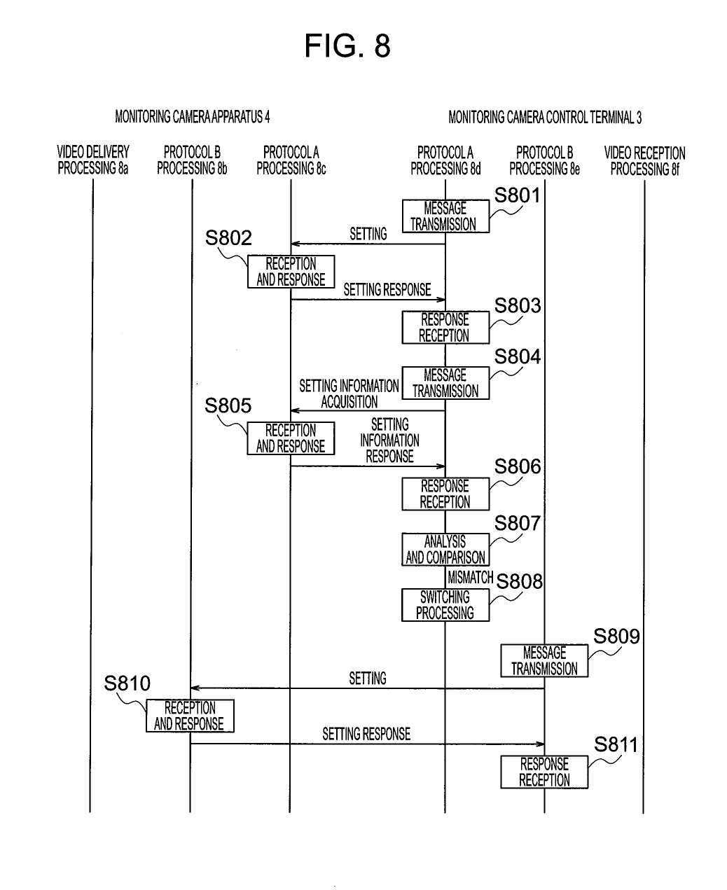

FIG. 8 is a diagram explaining a flow of a series of processing in which the monitoring camera control terminal 3 uses the protocol A to perform a variety of settings of the monitoring camera apparatus 4, receives setting information sent from the monitoring camera apparatus 4, and when the setting of the monitoring camera apparatus 4 is different from the above setting as a result of analyzing the setting information, changes the protocol to be used, and uses the protocol B to perform continuous processing of the control of a variety of settings, operations and the like.

The monitoring camera control terminal 3 performs protocol A processing 8d, protocol B processing 8e and video reception processing 8f, and the monitoring camera apparatus 4 performs video delivery processing 8a, protocol B processing 8b and protocol A processing 8c.

In this embodiment, the monitoring camera control terminal 3 uses the protocol A to start the control of the monitoring camera apparatus 4.

In S801, the monitoring camera control terminal 3 receives the instruction of the operator 5 by the operation reception part 42 and transmits the instruction to the instruction interpretation and switching part 41. The instruction interpretation and switching part 41 transmits information required for the control message responding to the instruction according to the protocol A to the protocol A processing part 40, and the protocol A processing part 40 sends a control message responding to the instruction to the protocol A processing part 50 of the monitoring camera apparatus 4. The control message of this embodiment is determined as a control message for setting the image sensor part 304, the image processing part 305, the network interface 306, and the image interface 308 of the monitoring camera apparatus 4.

In S802, the monitoring camera apparatus 4 receives the control message, which was sent in S801, by the protocol A processing part 50 and transmits information for setting contained in the control message to the hardware control driver part 51. The hardware control driver part 51 performs setting of the image sensor part 304, the image processing part 305, the network interface 306, and the image interface 308 of the monitoring camera apparatus 4 according to the above setting instruction. And, a response message showing that the control message received by the protocol A processing part 50 was normally received and the setting was made according to the setting information is sent to the protocol A processing part 40 of the monitoring camera control terminal 3.

In S803, the monitoring camera control terminal 3 receives the response message sent in S802 by the protocol A processing part 40 and confirms that the control message sent in S801 was received by the monitoring camera apparatus 4. S801 to S803 may be repeated a plurality of times until the monitoring camera apparatus 4 is set as desired by the operator 5.

In S804, the monitoring camera control terminal 3 accepts the instruction of the operator 5 to obtain setting information of the monitoring camera apparatus 4 by the operation reception part 42, and transmits the instruction to the instruction interpretation and switching part 41. The instruction interpretation and switching part 41 transmits information required for a control message responding to the instruction according to the protocol A to the protocol A processing part 40. The protocol A processing part 40 sends a control message for obtaining the setting information of the monitoring camera apparatus 4 responding to the instruction to the protocol A processing part 50 of the monitoring camera apparatus 4. The control message for obtaining the setting information in this embodiment is determined to be a control message for obtaining current setting information such as the image sensor part 304, the image processing part 305, the network interface 306, and the image interface 308 of the monitoring camera apparatus 4.

In S805, the monitoring camera apparatus 4 receives the control message sent in S804 by the protocol A processing part 50, and transmits information for obtaining the setting information contained in the control message to the hardware control driver part 51. The hardware control driver part 51 obtains designated setting information from the image sensor part 304, the image processing part 305, the network interface 306, and the image interface 308 of the monitoring camera apparatus 4 according to the instruction for obtaining the setting information, and transmits to the protocol A processing part 50. The protocol A processing part 50 sends a response message containing the setting information to the protocol A processing part 40 of the monitoring camera control terminal 3.

In S806, the monitoring camera control terminal 3 receives the response message sent in S805 by the protocol A processing part 40 and obtains the setting information of the monitoring camera apparatus 4 that the control message sent in S804 was received by the monitoring camera apparatus 4 and requested to obtain.

In S807, the monitoring camera control terminal 3 compares the setting information of the monitoring camera apparatus 4 obtained in S806 by the setting information interpretation and comparing part 44 with the setting information of the monitoring camera apparatus 4 instructed by the operator 5 recorded in the instruction storing part 45 of the monitoring camera control terminal 3. If they match as a compared result, processing from S801 to S807 can be repeated arbitrarily. If they do not match, the processing is advanced to S808. In this embodiment, it is assumed that the setting information of the monitoring camera apparatus 4 obtained in S806 and the setting information of the monitoring camera apparatus 4 instructed by the operator 5 did not match.

In S808, the monitoring camera control terminal 3 switches the protocol used to control the monitoring camera apparatus 4 from the protocol A to the protocol B in the instruction interpretation and switching part 41, and the later instruction from the operator 5 obtained via the operation reception part 42 controls the monitoring camera apparatus 4 by using the protocol B processing part 43. Accordingly, the availability of the control of the monitoring camera apparatus 4 can be enhanced so that a defect in software or the like of the monitoring camera apparatus 4 does not cause the monitoring camera apparatus 4 to operate against the intention of the operator, to make the operation inoperable, to deliver motion images in a state different from the intention, or to stop delivery of the motion images.

In S809, the monitoring camera control terminal 3 receives the instruction of the operator 5 in the operation reception part 42 and transmits the instruction to the instruction interpretation and switching part 41. The instruction interpretation and switching part 41 transmits information required for a control message responding to the instruction according to the protocol B to the protocol B processing part 43, and sends a control message responding to the instruction to the protocol B processing part 52 of the monitoring camera apparatus 4.

In S810, the monitoring camera apparatus 4 receives the control message, which was sent in S809, by the protocol B processing part 52, and transmits information for setting contained in the control message to the hardware control driver part 51, and the hardware control driver part 51 performs setting of the image sensor part 304, the image processing part 305, the network interface 306, and the image interface 308 of the monitoring camera apparatus 4 according to the above setting instruction. And, a response message showing that the control message received by the protocol B processing part 52 was normally received and the setting information was set is sent to the protocol B processing part 43 of the monitoring camera control terminal 3.

In S811, the monitoring camera control terminal 3 receives the response message sent in S810 in the protocol B processing part 43, and confirms that the control message sent in S809 was received by the monitoring camera apparatus 4.

S809 to S811 may be repeated plural times until the monitoring camera apparatus 4 is set as desired by the operator 5.

Subsequently, the same processing as in S801 to S807 is repeated arbitrarily by using the protocol B. Thus, the operator 5 can continue the desired control of the monitoring camera apparatus 4 without requiring a special operation or the like at all.

As described above, a flow of the protocol switching processing was shown in which the monitoring camera control terminal 3 uses the setting information sent from the monitoring camera apparatus 4 to judge whether or not the monitoring camera apparatus 4 is in a set state desired by the operator 5, and if it is not in the desired set state, a different protocol is used to continue the control such that it falls in the desired set state.

It was shown as described above that the control can be continued without interruption at all so that the monitoring camera apparatus 4 falls in the set state desired by the operator 5, and the availability of the control between the monitoring camera control terminal 3 and the monitoring camera apparatus 4 is improved.

While the monitoring camera apparatus 4 is being controlled according to the protocol B, it is possible to restart the software according to the protocol A, to fix a defect, to update or the like, and the availability of control between the monitoring camera apparatus 4 and the monitoring camera control terminal 3 can be improved in the camera system 1 as a whole.

### Switching of Protocol when Obtaining Motion Image Data

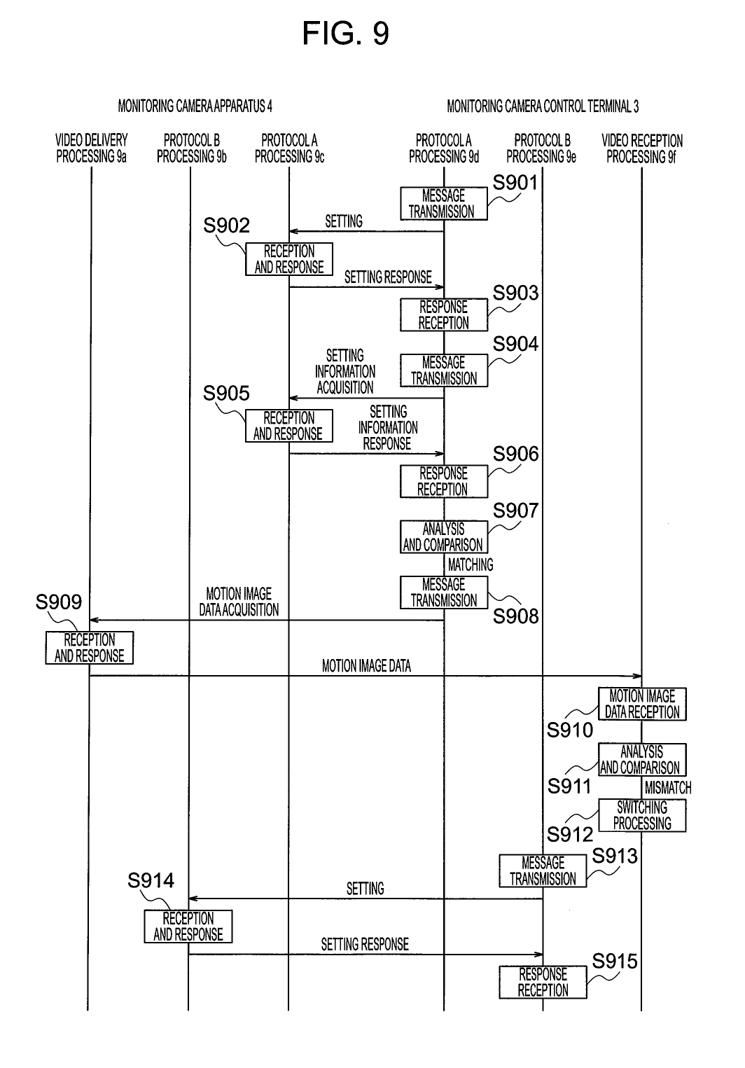

FIG. 9 is a diagram explaining a flow of a series of processing in which after a variety of settings and operations of the monitoring camera apparatus 4 are performed using the protocol A, the monitoring camera control terminal 3 receives motion image data delivered from the monitoring camera apparatus 4, and if the settings and operations of the monitoring camera apparatus 4 are different from the former settings and operations as a result of analyzing the motion image data, the used protocol is switched, and the protocol B is used to perform continuous processing to control a variety of settings and operations.

The monitoring camera control terminal 3 executes a protocol A processing 9d, a protocol B processing 9e and a video reception processing 9f, and the monitoring camera apparatus 4 executes a video delivery processing 9a, a protocol B processing 9b and a protocol A processing 9c.

It is assumed in this embodiment that the monitoring camera control terminal 3 uses the protocol A to start the control of the monitoring camera apparatus 4.

The flow of processing from S901 to S906 is same as the flow of processing from S801 to S806 of FIG. 8.

In S907, the monitoring camera control terminal 3 compares in the setting information interpretation and comparing part 44 the setting information of the monitoring camera apparatus 4 obtained in S906 with the setting information of the monitoring camera apparatus 4 recorded in the instruction storing part 45 of the monitoring camera control terminal 3 and instructed by the operator 5. If they match as a compared result, the processing from S901 to S907 can be repeated arbitrarily, and the processing is advanced to S908. It is assumed in this embodiment that the setting information of the monitoring camera apparatus 4 matches the setting information of the monitoring camera apparatus 4 instructed by the operator 5.

In S908, the monitoring camera control terminal 3 accepts the instruction of the operator 5 to obtain motion image data of the monitoring camera apparatus 4 by the operation reception part 42, and transmits the instruction to the instruction interpretation and switching part 41. The instruction interpretation and switching part 41 transmits the information required for a control message to obtain motion image data responding to the instruction according to the protocol A to the protocol A processing part 40, and the protocol A processing part 40 sends a control message for obtaining motion image data delivered by the monitoring camera apparatus 4 responding to the instruction to the video delivery part 53 of the monitoring camera apparatus 4.

In S909, the monitoring camera apparatus 4 receives a motion image data acquisition request message sent in S908 in the video delivery part 53, and sends the requested motion image data to the motion image data processing part 46 of the monitoring camera control terminal 4.

In S910, the monitoring camera control terminal 3 receives the motion image data sent in S909 in the motion image data processing part 46.

In S911, the monitoring camera control terminal 3 performs motion image data processing such as decode processing or the like of the motion image data obtained in S910 by the motion image data interpretation and comparing part 47, extracts information such as a codec, resolution, a frame rate, a bit rate or the like from the motion image data or presumes the movement of the lens part 303 from the whole tendency of movement of each pixel in the motion image data, and compares the obtained information with the setting or operation information of the monitoring camera apparatus 4 recorded in the instruction storing part 45 of the monitoring camera control terminal 3 instructed by the operator 5. If they match as a compared result, the processing from S901 to S911 can be repeated arbitrarily. If they do not match, the processing is advanced to S912. In this embodiment, it is determined that a variety of types of information obtained from the motion image data delivered from the monitoring camera apparatus 4 did not match the setting or operation information of the monitoring camera apparatus 4 instructed by the operator 5.

In S912, the monitoring camera control terminal 3 switches the protocol which is used to control the monitoring camera apparatus 4 from the protocol A to the protocol B in the instruction interpretation and switching part 41, and the subsequent instruction from the operator 5 obtained via the operation reception part 42 controls the monitoring camera apparatus 4 by using the protocol B processing part 46. Accordingly, the availability of the control of the monitoring camera apparatus 4 can be enhanced so that a defect in software or the like of the monitoring camera apparatus 4 does not cause the monitoring camera apparatus 4 to operate against the intention of the operator, to make the operation inoperable, to deliver motion images in a state different from the intention, or to stop delivery of the motion images.

A flow of the processing from S913 to S915 is same as the flow of processing from S809 to S811 of FIG. 8.

Subsequently, the same processing as in S901 to S911 is repeated arbitrarily by using the protocol B. Thus, the operator 5 can continue the desired control of the monitoring camera apparatus 4 without requiring a special operation or the like at all.

As described above, a flow of the protocol switching processing was shown in which the monitoring camera control terminal 3 uses the motion image data sent from the monitoring camera apparatus 4 to judge whether or not the monitoring camera apparatus 4 is in a set or operation state desired by the operator 5, and if it is not in the desired set or operation state, a different protocol is used to continue the control such that it falls in the desired set or operation state.

It was shown as described above that the control can be continued without interruption at all so that the monitoring camera apparatus 4 falls in the set state desired by the operator 5, and the availability of the control between the monitoring camera control terminal 3 and the monitoring camera apparatus 4 is improved.

### Modified Example

In the camera system 1 of this embodiment, the monitoring camera control terminal 3 is provided with the instruction interpretation and switching part 41, the setting information interpretation and comparing part 44 and the instruction storing part 45, but it may also be embodied to provide them to the monitoring camera apparatus 4. And, when the monitoring camera apparatus 4 checks by itself whether or not the instruction from the monitoring camera control terminal 3 is observed, and if not matched, the used protocol may be switched by blocking the protocol A processing part 50 which performs processing of the currently used protocol or by notifying from the protocol A processing part 50 to the monitoring camera control terminal 3.

In the examples shown in FIG. 8 and FIG. 9 of this embodiment, after the used protocol is switched in S808 or S912, S809 or S913 continues the control by accepting the instruction of the operator 5 by the operation reception part 42, but S809 or S913 and subsequent processing may be performed automatically with reference to the instruction storing part 45 until setting of the monitoring camera apparatus 4 desired by the operator 5.

Although the embodiments of the invention have been described above, the availability of the control of the monitoring camera apparatus can be enhanced according to the above embodiments, so that a defect in software or the like of the monitoring camera apparatus does not cause the monitoring camera apparatus to operate against the intention of the operator, to make the operation inoperable, to deliver motion images in a state different from the intention, or to stop delivery of the motion images.

The present invention is not limited to the above embodiments, and a variety of modifications may be made without departing from the spirit of the invention.

1. A camera system comprising:
a monitoring camera control terminal; and
a monitoring camera apparatus which is connected to the monitoring camera control terminal through a network, wherein:
the monitoring camera control terminal and the monitoring camera apparatus respectively correspond to a plurality of protocols which define messages instructing a variety of settings and operations between the monitoring camera control terminal and the monitoring camera apparatus;
the monitoring camera control terminal uses a first protocol to request the monitoring camera apparatus for information related to the monitoring camera apparatus;
the monitoring camera control terminal receives the requested information from the monitoring camera apparatus, and if the requested information does not match the setting or operation information recorded in a storage part of the monitoring camera control terminal, changes the first protocol to a second protocol; and
the monitoring camera apparatus sends the setting information to the monitoring camera control terminal in response to the request from the monitoring camera control terminal.

2. The camera system according to claim 1, wherein:
the monitoring camera control terminal uses the first protocol to request the monitoring camera apparatus to make setting of the monitoring camera apparatus and to obtain its setting information;
the monitoring camera control terminal receives the setting information from the monitoring camera apparatus, and if the setting information does not match the setting or operation information recorded in the storage part of the monitoring camera control terminal, changes the first protocol to a second protocol; and
the monitoring camera apparatus sends the setting information to the monitoring camera control terminal in response to the request to obtain the setting information from the monitoring camera control terminal.

3. The camera system according to claim 2, wherein:
if the received setting information matches the setting or operation information recorded in the storage part of the monitoring camera control terminal, the monitoring camera control terminal requests the monitoring camera apparatus to obtain motion image data;
the monitoring camera control terminal receives the motion image data from the monitoring camera apparatus, and if the information obtained by analyzing the motion image data does not match the setting or operation information recorded in the storage part, changes the first protocol to the second protocol; and
the monitoring camera apparatus sends the motion image data to the monitoring camera control terminal in response to the request of the monitoring camera control terminal to obtain the motion image data.

4. A monitoring camera control terminal which is connected to a monitoring camera apparatus through a network, wherein the monitoring camera apparatus and the monitoring camera control terminal respectively correspond to a plurality of protocols defining messages instructing a variety of settings and operations between the monitoring camera apparatus and the monitoring camera control terminal,
said monitoring camera control terminal comprises:
a unit which uses a first protocol to request the monitoring camera apparatus for information related to the monitoring camera apparatus; and
a unit which receives the requested information from the monitoring camera apparatus, and if the requested information does not match the setting or operation information recorded in a storage part of the monitoring camera control terminal, changes the first protocol to a second protocol.

5. The monitoring camera control terminal according to claim 4, wherein:
the monitoring camera control terminal uses the first protocol to request the monitoring camera apparatus to make setting of the monitoring camera apparatus and to obtain its setting information; and
the monitoring camera control terminal receives the setting information from the monitoring camera apparatus, and if the setting information does not match the setting or operation information recorded in the storage part of the monitoring camera control terminal, changes the first protocol to the second protocol.

6. The monitoring camera control terminal according to claim 5, wherein:
if the received setting information matches the setting or operation information recorded in the storage part of the monitoring camera control terminal, the monitoring camera control terminal requests the monitoring camera apparatus to obtain motion image data; and
the monitoring camera control terminal receives the motion image data from the monitoring camera apparatus, and if information obtained by analyzing the motion image data does not match the setting or operation information recorded in the storage part, changes the first protocol to the second protocol.

7. A protocol changing method for a monitoring camera control terminal which is connected to a monitoring camera apparatus through a network, wherein the monitoring camera apparatus and the monitoring camera control terminal respectively correspond to a plurality of protocols defining messages instructing a variety of settings and operations between the monitoring camera apparatus and the monitoring camera control terminal,
said control changing method comprises the steps of:
using a first protocol to request the monitoring camera apparatus for information related to the monitoring camera apparatus; and
receiving the requested information from the monitoring camera apparatus, and if the requested information does not match the setting or operation information recorded in a storage part of the monitoring camera control terminal, changes the first protocol to a second protocol.

8. The protocol changing method according to claim 7, wherein:
the first protocol is used by the monitoring camera control terminal to request the monitoring camera apparatus to perform setting of the monitoring camera apparatus and to obtain its setting information; and
the setting information is received from the monitoring camera apparatus, and if the setting information does not match the setting or operation information recorded in the storage part of the monitoring camera control terminal, the first protocol is changed to a second protocol.

9. The protocol changing method according to claim 8, wherein:
if the received setting information by the monitoring camera control terminal matches the setting or operation information recorded in the storage part of the monitoring camera control terminal, a request to obtain motion image data is made to the monitoring camera apparatus; and
the motion image data is received from the monitoring camera apparatus, and if information obtained by analyzing the motion image data does not match the setting or operation information recorded in the storage part, the first protocol is changed to a second protocol.
